(19) United States
(12) Patent Application Publication
(10) Pub. No.: US 2015/0307963 A1
(43) Pub. Date: Oct. 29, 2015

(54) MAGNESIUM REFINING APPARATUS AND MAGNESIUM REFINING METHOD

(71) Applicant: NIKON CORPORATION, Tokyo (JP)

(72) Inventors: Tatsuo NIWA, Sakura (JP); Kenichi KAWABE, Yokohama (JP); Fumitaka AKEDA, Yokohama (JP)

(73) Assignee: NIKON CORPORATION, Tokyo (JP)

(21) Appl. No.: 14/795,438

(22) Filed: Jul. 9, 2015

Related U.S. Application Data
(63) Continuation of application No. PCT/JP2014/050235, filed on Jan. 9, 2014.

(30) Foreign Application Priority Data
Jan. 9, 2013 (JP) 2013-002067

(51) Int. Cl. C22B 26/22; F27B 5/14; F24J 2/18; F24J 2/40; C22B 5/16; F24J 2/02

(52) U.S. Cl. CPC C22B 26/22; C22B 5/16; F24J 2/02; F24J 2/18; F24J 2/40; F27B 5/14

(57) ABSTRACT

A magnesium refining apparatus includes: a container that contains sample containing a magnesium compound; and a light concentrating device that concentrates sunlight to irradiate the container in order to heat an interior of the container to a predetermined temperature, wherein: the container has a reaction unit that is heated to the predetermined temperature by the light concentrating device to generate magnesium vapor from the sample with a thermal reduction reaction; and the light concentrating device is constructed of Cassegrain optical system having a first mirror surface constituted by a concave mirror and a second mirror surface constituted by a convex mirror, and concentrates reflected light of the sunlight on a surface of the sample in the container by guiding the sunlight reflected at the first mirror surface to the second mirror surface and then by reflecting the reflected sunlight guided from the first mirror surface at the second mirror surface.

### INCORPORATION BY REFERENCE

This application is a continuation of international application No. PCT/JP2014/050235 filed Jan. 9, 2014.

The disclosures of the following priority applications are herein incorporated by reference:

Japanese Patent Application No. 2013-2067 filed Jan. 9, 2013;
International Application No. PCT/JP2014/050235 filed Jan. 9, 2014.

### BACKGROUND OF THE INVENTION

1. Field of the Invention

The present invention relates to a magnesium refining apparatus and a magnesium refining method.

2. Description of Related Art

Japanese Translation of PCT International Application Publication No. 2010-535308 discloses that techniques of reducing metal oxides using energy of sunlight, which is natural energy.

### SUMMARY OF THE INVENTION

However, if magnesium is refined by heating it with energy of the sunlight, it is necessary to keep the heating temperature constant.

According to the 1st aspect of the present invention, a magnesium refining apparatus comprises: a container that contains sample containing a magnesium compound; and a light concentrating device that concentrates sunlight to irradiate the container in order to heat an interior of the container to a predetermined temperature, wherein: the container has a reaction unit that is heated to the predetermined temperature by the light concentrating device to generate magnesium vapor from the sample with a thermal reduction reaction; and the light concentrating device is constructed of Cassegrain optical system having a first mirror surface constituted by a concave mirror and a second mirror surface constituted by a convex mirror, and concentrates reflected light of the sunlight on a surface of the sample in the container by guiding the sunlight reflected at the first mirror surface to the second mirror surface and then by reflecting the reflected sunlight guided from the first mirror surface at the second mirror surface.

According to the 2nd aspect of the present invention, the magnesium refining apparatus according to the 1st aspect may further comprise: a drive unit that drives the second mirror surface to shift a concentrating position of the sunlight at least one of on the surface of the sample and on an optical axis of the sunlight.

According to the 3rd aspect of the present invention, the magnesium refining apparatus according to the 2nd aspect may further comprise: a sun position detector that detects direct light reaching from the sun to the light concentrating device; a pressure detector that detects a pressure in the reaction unit of the container; and a temperature detector that detects a temperature in the reaction unit, wherein: the drive unit drives the second mirror surface in dependence on at least one of or a combination of the detection results from the sun position detector, the pressure detector, and the temperature detector.

According to the 4th aspect of the present invention, the magnesium refining apparatus according to the 3rd aspect may further comprise: a speed determination unit that determines a conveying speed of the sample in the container in dependence on at least one of or a combination of the detection results from the sun position detector, the pressure detector, and the temperature detector.

According to the 5th aspect of the present invention, a magnesium refining method comprises: containing sample containing a magnesium compound in a container; heating an interior of the container to a predetermined temperature by reflecting sunlight at a first mirror surface constituted by a concave mirror and guiding to a second mirror surface constituted by a convex mirror, and then reflecting the light at the second mirror surface to concentrate the light on a surface of the sample in the container; generating magnesium vapor from the sample with a thermal reduction reaction in a reaction unit provided in the container; and condensing the magnesium vapor in a condenser unit provided in the container.

According to the 6th aspect of the present invention, the magnesium refining method according to the 5th aspect may further comprise: driving the second mirror surface to shift a concentrating position of the sunlight at least one of on the surface of the sample and on an optical axis of the sunlight.

According to the 7th aspect of the present invention, the magnesium refining method according to the 6th aspect may further comprise: detecting direct light reaching from the sun; detecting a pressure in the reaction unit of the container; detecting a temperature in the reaction unit; and driving the second mirror surface in dependence on at least one of or a combination of the detected direct light, the detected pressure in the reaction unit, and the detected temperature in the reaction unit.

According to the 8th aspect of the present invention, the magnesium refining method according to the 7th aspect may further comprise: determining a conveying speed of the sample in dependence on at least one of or a combination of the detected direct light, the detected pressure in the reaction unit, and the detected temperature in the reaction unit.

According to the present invention, samples in a container can be heated at a predetermined temperature required for the thermal reduction reaction by concentrating the sunlight with the light concentrating device to irradiate the container.

### BRIEF DESCRIPTION OF THE DRAWINGS

FIG. 1 is a configuration view illustrating one example of a magnesium refining apparatus according to a first embodiment of the present invention.

FIG. 2 is a view schematically illustrating a configuration of a retort according to the first embodiment.

FIG. 3 is a view illustrating an influence of an added quantity of calcium on an ignition temperature of the magnesium alloy.

FIG. 4 is a system diagram illustrating a system of forming a flame-retardant magnesium alloy and a recycling system.

FIG. 5 is a configuration view illustrating one example of a magnesium refining apparatus according to a second embodiment.

FIG. 6 is a configuration view illustrating one example of an interior of a retort according to a second embodiment.

FIG. 7 is a configuration view illustrating one example of an interior of a retort according to a second embodiment.

FIG. 8 is a view explaining a size of an opening provided in the condenser shield.

FIG. 9A is a flowchart explaining a driving process of a conveying device; FIG. 9B is a flowchart explaining a driving process of a secondary mirror; and FIG. 9C is a flowchart explaining a magnesium refining method using the magnesium refining apparatus.

### DESCRIPTION OF PREFERRED EMBODIMENTS

The Pidgeon process has been conventionally known as one of methods of refining magnesium. In the Pidgeon process, dolomite ore (CaMg(CO₃)₂) is calcined to form an oxide, and the oxide and ferrosilicon are mixed to form briquettes. The formed briquettes are placed in a reaction furnace (retort) and constantly heated under vacuum at a high temperature of about 1200° C. for about 8 hours so that a vapor of magnesium is generated by a thermal reduction reaction. The magnesium vapor is condensed to extract magnesium in a crystal form. Since high purity magnesium is inflammable and presents a risk in transportation, other elements are incorporated in the magnesium to form a magnesium alloy that is flame-retardant. In other words, in forming the magnesium alloy, magnesium is incorporated with required materials and then heated again to obtain a desired alloy.

In order to obtain the flame-retardant magnesium alloy with the thermal reduction process according to the above-described Pidgeon process, it is necessary to increase the temperature to about 1400° C., which is further higher than 1200° C. As a result, the magnesium alloy is not feasible due to the facts that a larger amount of carbon dioxide is generated to cause a further detrimental effect on the environment, and that the manufacturing cost for forming magnesium is increased because the service life of a gas furnace or retort is shortened owing to the heating at the high temperature of 1400° C. Moreover, also when the magnesium alloy is formed in a subsequent process, the apparatus is intensively loaded and carbon dioxide is generated.

### First Embodiment

A first embodiment of the present invention relates to a magnesium refining apparatus that prevents carbon dioxide to be generated as described above, is highly resistant to heating at a high temperature for a long time, and has a low environmental load. The magnesium refining apparatus according to this embodiment utilizes energy of sunlight concentrated by a solar furnace to heat samples (briquettes) at a predetermined temperature in order to refine magnesium with the thermal reduction reaction. In this way, the flame-retardant magnesium is formed owing to a predetermined quantity of calcium included in the magnesium refined with the thermal reduction reaction. In this case, heating is performed to a temperature at which the vapor pressure of calcium is at a predetermined percentage with respect to the vapor pressure of magnesium during the thermal reduction reaction. That is, the flame-retardant magnesium containing calcium is obtained by increasing the temperature of forming magnesium with the thermal reduction reaction using the conventional Pidgeon process. This will now be described in detail.

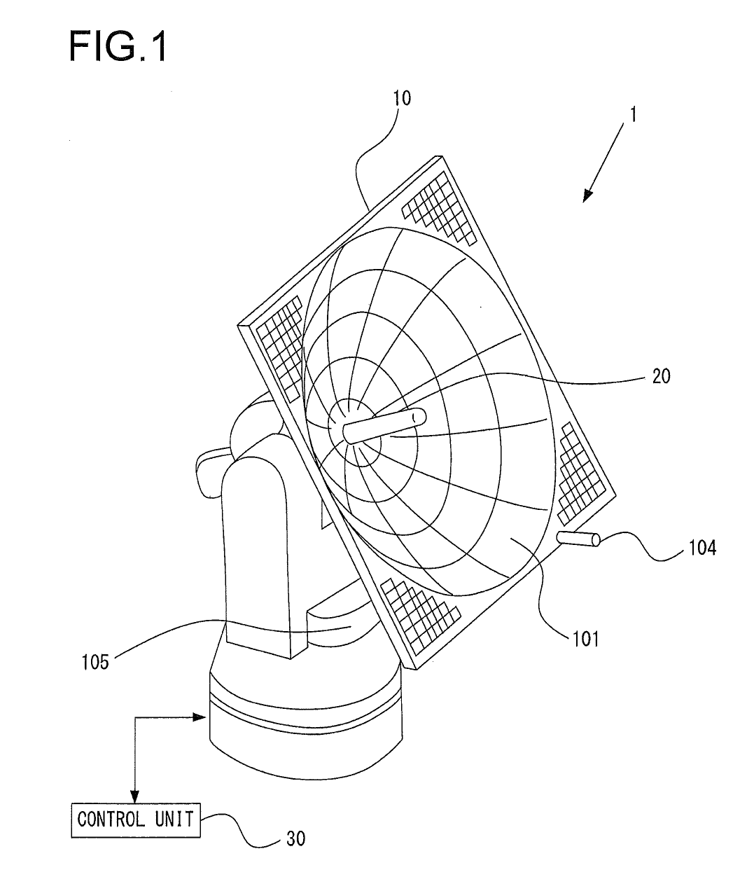

FIG. 1 is a view illustrating an example of a configuration of a magnesium refining apparatus 1. The magnesium refining apparatus 1 includes a light concentrating unit 10, a retort 20, and a control unit 30. The light concentrating unit 10 in this embodiment has a main mirror 101, a direct light sensor 104, and a drive mechanism 105.

The main mirror 101 is constituted of a plurality of concave mirrors and plane mirrors that combine together to form a parabolic surface. The main mirror 101 is configured to have a light concentrating power of 2000× or more and form a focal point at a position into which samples in the retort 20 are carried, in order to locally achieve a high temperature of e.g. about 1400° C. in the retort 20. Thus, energy of sunlight heats the samples in the retort 20 with the aid of the main mirror 101 of the light concentrating unit 10.

The main mirror 101 drives in a horizontal direction and/or in a pitch direction in accordance with movement of the sun and therefore traces the sun so that the main mirror 101 faces the sun, using well-known techniques. In this case, the control unit 30 calculates a drive quantity by which the main mirror 101 is driven to face the sun, as a function of a position of the sun that is calculated on the basis of the time of the day or an installation position (for example, latitude and altitude information) of the light concentrating unit 10, and as a function of a signal in accordance with a quantity of direct solar radiation (direct solar radiation signal) that is input from the direct light sensor 104. The drive mechanism 105 drives the main mirror 101 in the horizontal direction and/or the pitch direction, in response to input of a drive signal indicating the drive quantity calculated by the control unit 30.

The retort 20 is configured to removably attach to the main mirror 101 and serves as both a container for containing briquettes B (samples) therein, and a reaction furnace in which magnesium is separated with the thermal reduction reaction by heating the briquettes B with energy of sunlight.

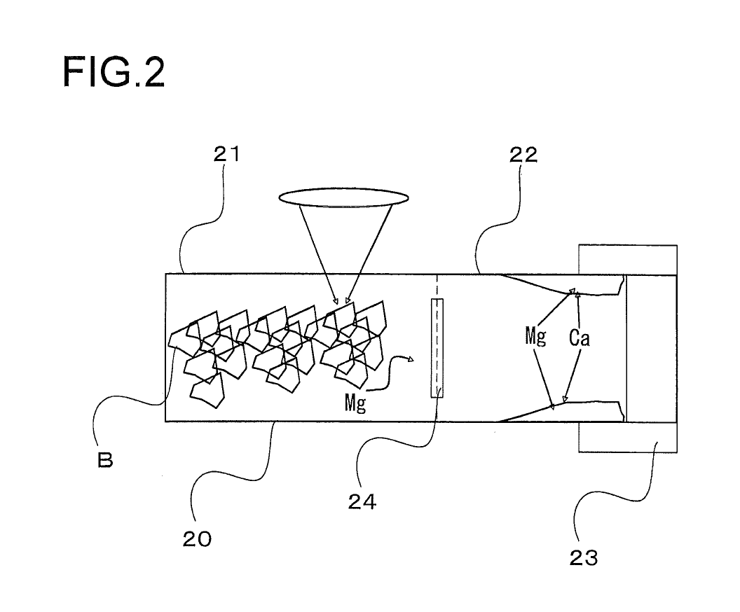

FIG. 2 schematically illustrates a structure of the retort 20. The retort 20 is a hollow cylindrical member made of a heat resistant material. The retort 20 may be connected to a vacuum pump or the like (not depicted) to maintain a vacuum in the retort 20. As described later, the briquettes B contain at least MgO and CaO.

The retort 20 has a reaction unit 21 in which the briquettes B are irradiated with the concentrated sunlight to generate magnesium vapor with the thermal reduction reaction, a condenser 22 for collecting the generated magnesium vapor, a cooling unit 23 for cooling the condenser 22, and a heat shield panel 24 for shielding heat from the reaction unit 21. The retort 20 is attached to the main mirror 101 on the cooling unit 23 side. The briquettes B are placed in the reaction unit 21 and irradiated with the sunlight concentrated by the light concentrating unit 10. The briquettes B irradiated with the sunlight are locally heated up to a temperature that is higher than the boiling point (1107° C.) of magnesium, e.g. about 1400° C. Consequently, the briquettes B are subjected to the reduction reaction to generate magnesium in a vapor form, which is sucked into the condenser 22 by a suction device (not depicted). It should be noted that a small amount of calcium is also vaporized and reaches the condenser 22 because the boiling point of calcium is 1487° C. In this embodiment, the temperature to which the briquettes B are heated is set so that the vapor pressure of calcium is 1% to 5% with respect to the vapor pressure of magnesium, as one example.

The condenser 22 is cooled by the cooling unit 23 so that the temperature in the condenser 22 is maintained at a predetermined temperature, e.g. an appropriate temperature equal to or lower than the melting point of magnesium. In this embodiment, the cooling unit 23 is a water-cooling type cooling device that cools the condenser 22 by the effect of cooling water utilizing seawater or the like, as one example. When the condenser 22 is cooled by the cooling unit 23, magnesium and calcium that have been vaporized in the reaction unit 21 are sucked by the sucking device into the condenser 22, where they condense and separate as an alloy of magnesium having several percent of calcium incorporated therein. The separated magnesium alloy is taken out from the condenser 22 to obtain a flame-retardant magnesium alloy.

As a method of forming the briquettes B, it is possible to employ a method using mined dolomite as a raw material as in conventional techniques (for example, the Pidgeon process), and a method using magnesium hydroxide Mg(OH)₂ extracted from bittern or the like obtained by purifying seawater or magnesium hydroxide Mg(OH)₂ extracted from spent electrode materials for fuel cells or other cells including magnesium as their electrode material, as a raw material.

In the case of using dolomite as the raw material, mined dolomite (CaCO₃ MgCO₃) is crushed and heated to form calcined dolomite (CaO.MgO) in accordance with the following chemical equation (1).

CaCO₃.MgCO₃→CaO.MgO+2CO₂ (1)

Additionally, a metal of silicon (Si), iron (Fe), calcium (Ca), and carbon (C) and its oxide, i.e. ferrosilicon (FeSi₂), which acts as a reducing agent of magnesium oxide (MgO), is formed in accordance with the following reaction equation (2).

Fe₂CO₃+4SiO₂+11C→2FeSi₂+11CO (2)

The calcined dolomite and ferrosilicon formed in accordance with the above-described equations (1) and (2) are mixed to form briquettes B having a predetermined size and shape.

In the case of using magnesium hydroxide Mg(OH)₂ as the raw material, calcium hydroxide Ca(OH)₂ is added to Mg(OH)₂ and then heated and dehydrated to form magnesium oxide (MgO) in accordance with the following chemical equation (3).

Mg(OH)₂+Ca(OH)₂→MgO+CaO+2H₂O (3)

Then, the ferrosilicon formed in accordance with the reaction equation (2) is mixed with magnesium oxide (MgO) to form briquettes B having a predetermined size and shape.

With the above-described magnesium refining apparatus 1, a refining process described later is achieved to form a flame-retardant magnesium alloy. The briquettes B formed by the above-described method are placed in the retort 20 and heated at a high temperature of about 1400° C., which causes the thermal reduction reaction represented by the following chemical equation (4).

2(MgO+CaO)+Si→2Mg+2CaO+SiO₂ (4)

As a result of the reaction represented by the above-described equation (4), magnesium generates in a vapor form and condenses in the condenser 22. At the same time, a small amount of calcium is also vaporized and incorporated in the magnesium vapor. Thus, magnesium containing a small amount of calcium condenses in the condenser 22. In this embodiment, the briquettes B are heated so that the vapor pressure of calcium is 1% or more with respect to the vapor pressure of magnesium, with the result that the alloy separated in the condenser 22 also has calcium incorporated therein in amount of 1% or more with respect to magnesium.

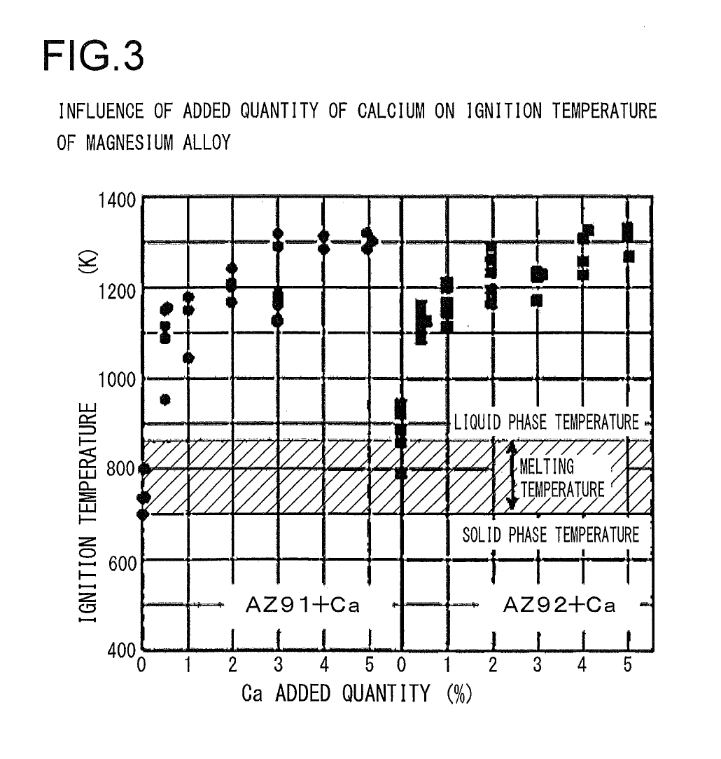

FIG. 3 is a view illustrating a relationship between an added quantity of calcium and an ignition temperature of the magnesium alloy. As illustrated in FIG. 3, the ignition temperature can be 1000 K or more when the added quantity of calcium exceeds 1%. This temperature is substantially higher than the ignition temperature of pure magnesium, 800 K or less. In the magnesium alloy formed by the magnesium refining apparatus 1 of this embodiment, the added quantity of calcium is 1% or more with respect to magnesium as described above. Thus, the magnesium alloy formed by the magnesium refining apparatus 1 is flame-retardant. Thereby, safety in transportation can be ensured.

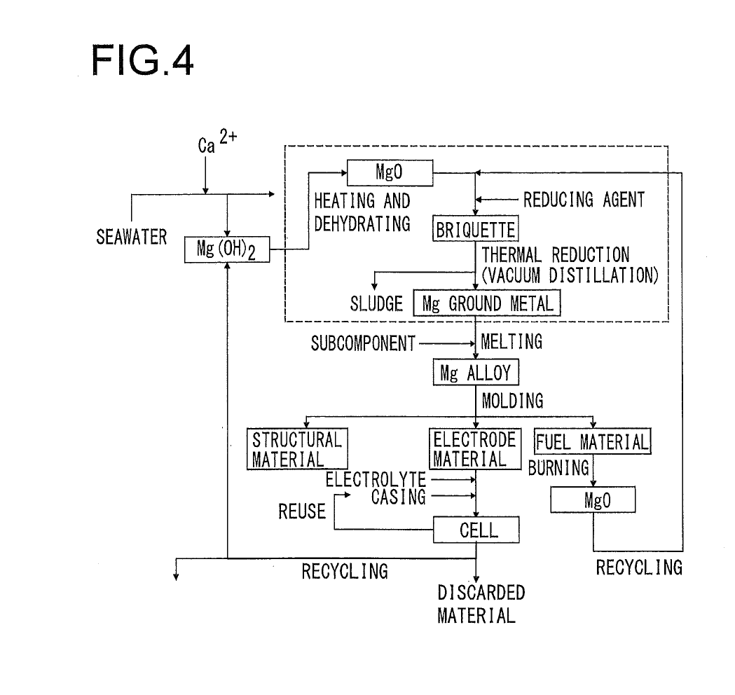

FIG. 4 illustrates a system of forming the flame-retardant magnesium alloy as described above and a recycling system. As illustrated in FIG. 4, the flame-retardant magnesium alloy can be formed and used for applications, such as a fuel material or an electrode material for fuel cells or the like. When the magnesium alloy is used as a fuel material, MgO remains as residue. This MgO is mixed with the ferrosilicon obtained in accordance with the chemical equation (2) to form the briquettes B, which are again carried into the retort 20 of the magnesium refining apparatus 1. Then, the flame-retardant magnesium alloy can again be formed by causing the thermal reduction reaction represented by the chemical equation (4). On the other hand, when the magnesium alloy is used as an electrode material for fuel cells, Mg(OH)₂ remains as residue. Here, MgO is formed by causing the reaction represented by the chemical equation (3) with this Mg(OH)₂. Then, in the same way as described above, the briquettes B are formed and carried into the retort 20 to cause the thermal reduction reaction, so that the flame-retardant magnesium alloy can again be formed. In this way, magnesium can be recycled with the magnesium refining apparatus 1. Additionally, sludge such as SiO₂ formed during the thermal reduction reaction represented by the chemical equation (4) can be reused as a reducing agent.

According to the magnesium refining apparatus according to the first embodiment described above, the following advantages can be achieved.

(1) The magnesium refining apparatus 1 includes the retort 20 that encloses the briquettes B as samples containing a magnesium compound, and the light concentrating unit 10 that concentrates and irradiates the sunlight onto the retort 20 in order to heat the interior of the retort 20 to a predetermined temperature. The retort 20 has the reaction unit 21 that is heated to a predetermined temperature by the light concentrating unit 10 to generate magnesium vapor from the briquettes B with the thermal reduction reaction. Hence, magnesium can be separated with the thermal reduction reaction using energy of sunlight. As a result, generation of carbon dioxide and associated detrimental effect on the environment are avoided, which would otherwise result from burning of fossil fuels in a gas furnace or the like and heating at a high temperature for a long time.

Specifically, the retort 20 can be heated up to the high temperature of 1400° C. by concentrating sunlight with the light concentrating unit 10. Magnesium is therefore subjected to the thermal reduction reaction while heating to about 1400° C., which can result in incorporation of calcium into magnesium to obtain a flame-retardant magnesium alloy. In the prior art, separated magnesium has been heated again to obtain an alloy having other components incorporated therein. In contrast, in this embodiment, heating at the high temperature of 1400° C. can be achieved in one process by using sunlight as heating energy by using the light concentrating unit 10, so that the process of manufacturing the flame-retardant magnesium can be simplified. Furthermore, emission of carbon dioxide is suppressed and a detrimental effect on the environment is avoided because it is not necessary to perform an additional heating process to obtain the alloy as in the prior art.

(2) The retort 20 further includes the condenser 22 that condenses the magnesium vapor. Thereby, the magnesium alloy can be efficiently obtained from the magnesium vapor generated with the thermal reduction reaction in the reaction unit 21 and therefore a drop in productivity can be suppressed.

The magnesium refining apparatus according to the first embodiment can be modified as follows:

(1) The magnesium refining apparatus 1 may be used to produce the raw material for forming the magnesium alloy, by changing the light concentrating power of the light concentrating unit 10 to change the heating temperature. In this case, the magnesium refining apparatus 1 is applicable to the process of forming MgO with calcination as represented by the above-described chemical equation (3) or the process of forming ferrosilicon with heating as represented by the chemical equation (2). As a result, it is not necessary to burn fossil fuels not only in forming the magnesium alloy, but also in calcining to form MgO or heating to form ferrosilicon, which are raw materials. Consequently, generation of carbon dioxide is suppressed and a detrimental effect on the environment is avoided for the entire system of generating the magnesium alloy.

(2) The method of heating the retort 20 is not limited to the method using the light concentrating unit 10 having the main mirror 101. Any method may be used that can concentrate and irradiate sunlight onto the retort 20 so that the interior of the retort 20 is heated to the temperature of 1400° C., in order to generate magnesium vapor from the briquettes B containing a magnesium compound contained in the retort 20 with the thermal reduction reaction. For example, the light concentrating unit 10 is of the Heliostat-type that superposes reflected lights that have been reflected from a plurality of respective plane mirrors and concentrates on one point.

### Second Embodiment

A material processing apparatus according to a second embodiment of the present invention will be described. In the following description, the same component as those of the first embodiment are denoted by the same reference numerals and differences between the first embodiment and the second embodiment will be mainly described. The matters that are not particularly described are the same as in the first embodiment. This embodiment is distinguished from the first embodiment by a structure of a light concentrating unit, a structure of a retort, and a method of collecting refined magnesium alloy.

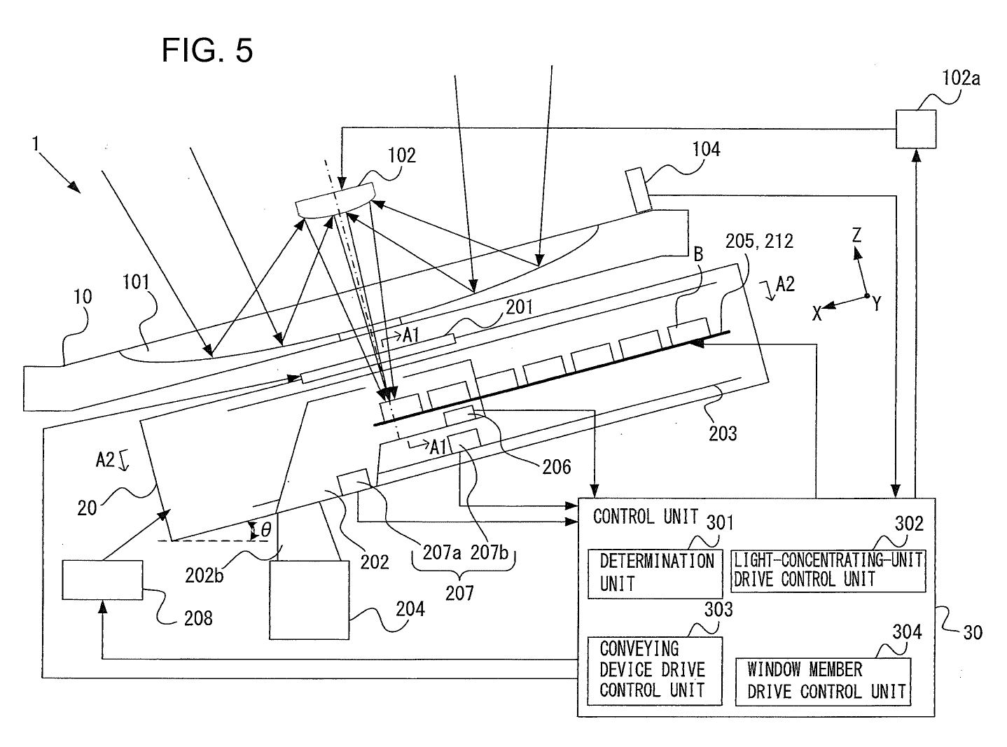

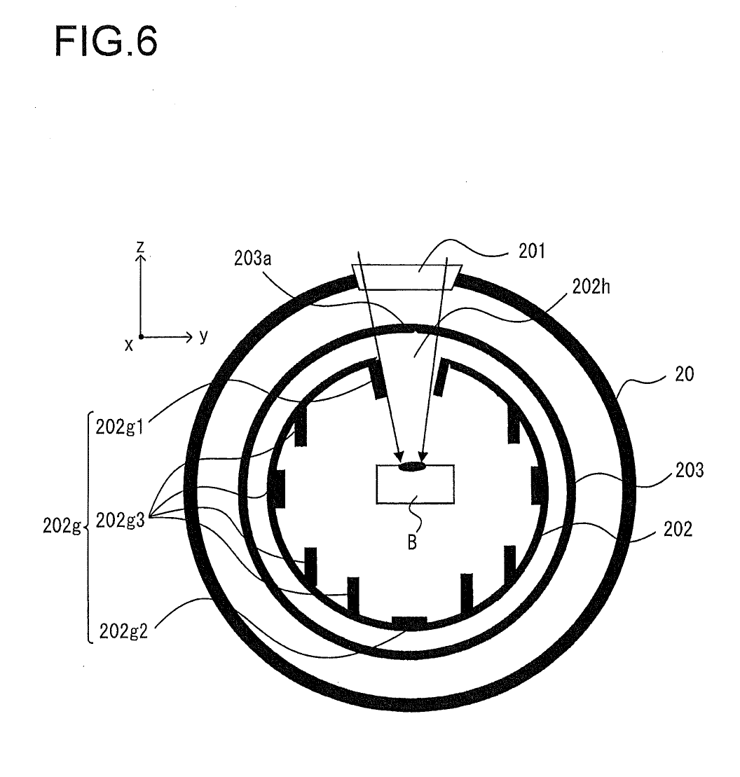

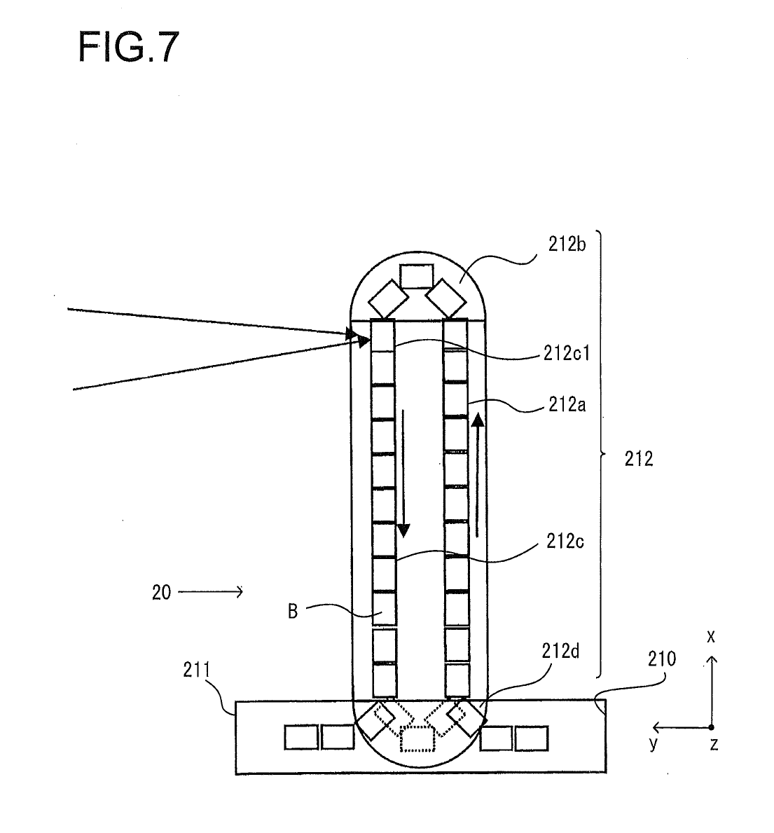

FIGS. 5 to 8 schematically illustrate a structure of a magnesium refining apparatus 1 according to the second embodiment. FIG. 6 is a cross-sectional view taken along a line A1-A1 of a retort 20 illustrated in FIG. 5, and FIG. 7 is a cross-sectional view taken along a line A2-A2 of the retort 20 illustrated in FIG. 5. For the purpose of explanation, x, y, z coordinate axes are set as illustrated in FIGS. 5 to 7.

A light concentrating unit 10 according to the second embodiment is constructed of Cassegrain optical system having the main mirror 101 constituted by a concave mirror and a secondary mirror 102 constituted by a convex mirror. In addition to the main mirror 101 having the parabolic surface, the light concentrating unit 10 further has the secondary mirror 102 constituted by a convex mirror having a hyperbolic surface and a drive mechanism 102a that drives the secondary mirror 102. An aluminum or silver film that has been subjected to an anti-corrosion treatment is used on the front side or back side of the main mirror 101. A dielectric multi-layer film mirror absorbing less energy is used on the front side or back side of the secondary mirror 102, for example. In the light concentrating unit 10, sunlight is reflected from the main mirror 101 and then advances to the secondary mirror 102. The secondary mirror 102 concentrates the light on an upper surface (on the z-axis positive side) of briquettes B conveyed into the retort 20 described later. It should be noted that the secondary mirror 102 is designed so that a numerical aperture (NA) is small when the sunlight concentrates on the briquettes B, for the purposes of efficiently concentrating the sunlight on the briquettes B and arranging the retort 20 on the back side of the main mirror 101. The drive mechanism 102a drives the secondary mirror 102 in accordance with a drive signal from a control unit 30 described later to change the light concentrating power of the sunlight concentrating on the surfaces of the briquettes B.

The control unit 30 allows the retort 20 to be supported by a attitude control mechanism (not depicted) so that the retort 20 is inclined by a predetermined angle θ with respect to the horizontal plane indicated by a dashed line in FIG. 5, with the result that one end (on the x-axis positive side) in a longitudinal direction of the retort 20 is lower in height than the other end (on the x-axis negative side). In other words, x-axis is set in a direction inclined by the predetermined angle θ with respect to the horizontal plane. It should be noted that the above-described predetermined angle θ is determined by experiments or the like, as an optimal angle for inflowing and dropping magnesium liquefied with the reduction reaction into a magnesium collection unit 204, as described later.

The retort 20 includes a window member 201, a condenser shield 202, a second shield 203, the magnesium collection unit 204, a conveying device 205, a temperature sensor 206, a pressure sensor 207, a pump 208, a briquette inlet 210, a briquette outlet 211, and a conveying path 212. The window member 201 covers an opening provided on the top (on z-axis positive side, i.e. on the light concentrating unit 10 side) of the retort 20 and transmits the sunlight concentrated by the light concentrating unit 10 into the retort 20. The window member 201 is configured to include a film (sunlight transmitting/infrared reflecting film) that transmits visible light (sunlight) and reflects infrared light, such as a transparent electrode ITO film (indium tin oxide film). The film reflects radiant heat from the condenser shield 202 described later. The window member 201 is exchangeably provided and has an extent larger than an extent of a light flux of the sunlight guided into the retort 20. The window member 201 is configured to be two-dimensionally movable on a plane parallel to the x-y plane in its installed position, by a drive mechanism (not depicted) in accordance with a drive signal output from the control unit 30.

The condenser shield 202 is provided in the retort 20 and is a hollow member made of a carbon steel. The condenser shield 202 is provided with an opening 202h so that the sunlight from the light concentrating unit 10 can irradiate the briquettes B. In the condenser shield 202, the briquettes B are conveyed on the conveying path 212 by the conveying device 205 described later and the briquettes B are irradiated in the condenser shield 202 with the sunlight through the opening 202h. Furthermore, a connecting unit 202b is provided at the bottom (on the z-axis negative side) of the condenser shield 202 on its end on the x-axis positive side so as to connect the magnesium collection unit 204 provided therebelow.

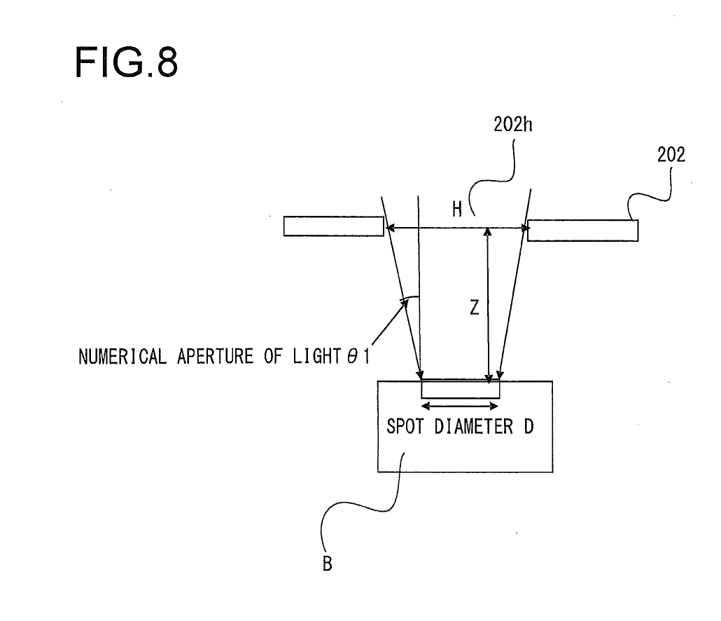

The diameter of the opening 202h will be described with reference to FIG. 8. In FIG. 8, Z denotes a distance in the z-axis direction between the upper surface (on the z-axis positive side) of the briquette B and an inner wall of the condenser shield 202, and D denotes a diameter (spot diameter) of the light flux of the sunlight from the light concentrating unit 10 on the upper surface of the briquette B. Given that the numerical aperture of the sunlight is 01, the diameter H of the opening 202h is designed to satisfy the following equation (5).

2(D+2Z tan θ1)≧H>D+2Z tan θ1 (5)

The interior of the condenser shield 202 is configured as follows: As illustrated in FIG. 6, a plurality of guide members 202g are provided in the condenser shield 202 so that magnesium is guided to the magnesium collection unit 204 through the connecting unit 202b in a liquid state. In the following description, among the plurality of guide members 202g, guide members provided along opening ends of the opening 202h are denoted by reference numeral 202g1, a guide member provided on the bottom (on the z-axis negative side) of the condenser shield 202 is denoted by reference numeral 202g2, and other guide members are denoted by reference numeral 202g3.

The guide members 202g1 project from the opening ends of the opening 202h in the z-axis negative direction. Each guide member 202g1 projects in a direction in which it does not block the light flux of the sunlight incident through the window member 201. In other words, the guide members 202g1 are shaped to cover the window member 201 so that separated magnesium liquid could not leak out in a direction of the window member 201. The guide member 202g2 is provided to extend along the x-axis direction on the inner wall of the condenser shield 202 on its bottom. The guide members 202g3 are provided to project from the inner wall of the condenser shield 202 along the z-axis direction and extend along the x-axis direction. The guide members 202g1 to 202g3 are formed to have a thickness larger than that of members constituting the condenser shield 202. The guide members 202g1 to 202g3 may project in a direction to a focal plane that is located in or around the center of the condenser shield 202. Furthermore, the guide members 202g1 to 202g3 may be not rectangular in cross section, but may project in a triangular form, for example. As described above, a large amount of magnesium can be separated because the surface area of the inner surface of the condenser shield 202 increases owing to the guide members 202g1 to 202g3 provided thereon.

The temperature in the condenser shield 202 is maintained at a temperature higher than the melting point (651° C.) of magnesium, e.g. about 700° C. to about 800° C. Moreover, the pressure in the condenser shield 202, except for the pressure of magnesium vapor, is adjusted to be 1 Pa or less. The magnesium that has been vaporized with the thermal reduction reaction therefore reaches the inner wall of the condenser shield 202 without oxidation and condenses there into a liquid to attach to the inner wall. In other words, the condenser shield 202 is an integral unit of a reaction unit for the thermal reduction reaction of the briquettes B and a condenser unit for the condensation of the magnesium vapor generated with the thermal reduction reaction. Because the retort 20 is inclined by the predetermined angle θ with respect to the horizontal plane as described above, the magnesium that is liquefied and attaches to the inner wall of the condenser shield 202 is guided in a direction to which the guide members 202g2 and 202g3 extend, i.e. along x-axis, under the influence of the gravity. The liquid magnesium that reaches an end surface on the x-axis positive side of the condenser shield 202 then flows or drops into the magnesium collection unit 204 through the connecting unit 202b.

The second shield 203 is provided to hold the condenser shield 202 therein. The second shield 203 is provided to prevent heat from dissipating to the outside through a housing outer wall of the retort 20 due to radiant heat from the condenser shield 202. The second shield 203 is made of a material that transmits the sunlight from the light concentrating unit 10 and reflects the radiant heat from the condenser shield 202. In this embodiment, a cylindrically formed member made of a transparent material such as quartz or glass having aluminum coated on its inner surface is used as the second shield 203. However, a range 203a where the sunlight from the light concentrating unit 10 passes through towards the briquettes B, i.e. a range corresponding to the window member 201 has no coating. Mirror-finished stainless may also be used as the second shield 203. Furthermore, the range 203a of the second shield 203 made of the transparent material such as quartz or glass may be provided with a dielectric multi-layer film or covered by a sunlight transmitting/infrared reflecting film such as an ITO film (indium tin oxide film). A combination of the second shield 203 made of stainless and a window part made of a transparent material is also conceivable. By providing the second shield 203 having the above-described structure in the retort 20, a space between the second shield 203 and the retort 20 is maintained at a temperature of about 200° C. As a result, heating of the housing outer wall of the retort 20 to a high temperature can be prevented.

As illustrated in FIG. 7, the retort 20 is provided therein with the briquette inlet 210 and the briquette outlet 211 in an end on the x-axis negative side of the retort 20, and the conveying path 212 connecting the briquette inlet 210 to the briquette outlet 211. The conveying path 212 is provided with a first conveying path 212a that conveys incoming briquettes B in the x-axis positive direction, a first curved conveying path 212b that is connected to the first conveying path 212a and changes the conveying direction of the briquettes B passed from the first conveying path 212a to the x-axis negative direction, a second conveying path 212c that is connected to the first curved conveying path 212b and conveys the briquettes B passed from the first curved conveying path 212b to the x-axis negative direction, and a second curved conveying path 212b that is connected to the second conveying path 212c and changes the conveying direction of the briquettes B passed from the second conveying path 212a to the x-axis positive direction. A part of the second conveying path 212c is a reaction conveying path 212c1 that extends in the interior of the condenser shield 202. The reaction conveying path 212c1 is provided to irradiate the briquettes B with the sunlight transmitting through the window member 201 for the thermal reduction reaction.

The conveying device 205 is constituted of a belt, a plurality of rollers, and other components provided along the conveying path 212. The conveying device 205 continuously and sequentially conveys the briquettes B having a predetermined shape to the condenser shield 202. In this embodiment, the briquettes B are cylindrically formed and conveyed on the conveying path 212 so that the central axes of the briquettes B align with the conveying direction. The conveying device 205 connects the briquette inlet 210 to the first conveying path 212a in the end on the x-axis negative side and conveys the briquettes B provided through the briquette inlet 210 in the x-axis positive direction in accordance with a drive signal from the control unit 30 as described later. Once the briquettes B are brought onto the first conveying path 212a, the conveying device 205 connects an end on the x-axis negative side of the first conveying path 212a to the second curved conveying path 212d so that an excessive number of the briquettes B would not be brought onto the conveying path 212. The briquettes B brought onto the conveying path 212 are conveyed on the first conveying path 212a, the first curved conveying path 212b, the second conveying path 212c, and the second curved conveying path 212d in this sequence, and again conveyed onto the first conveying path 212a. Then, they are conveyed on the conveying path 212 in the same sequence.

In the reaction conveying path 212c1 that is a part of the second conveying path 212c, the briquettes B move along the x-axis negative direction while a rotating mechanism (not depict) rotates the briquettes B around their central axes along the x-axis direction. This enhances the utilization efficiency of the briquettes B, because a wide range of the surfaces of the briquettes B is irradiated with the sunlight. The secondary mirror 102 is slightly driven by the drive mechanism 102a to shift the concentrating position along the direction of the optical axis of the sunlight. As a result, the surface temperature of the briquettes B remains a substantially constant high temperature, even if the surfaces of the briquettes B are deformed with the thermal reduction reaction to cause variations in the distance Z in the z-axis direction between the upper surface (on the z-axis positive side) of the briquette B and the inner wall of the condenser shield 202 illustrated in FIG. 8.

The briquettes B continues to be conveyed on the conveying path 212 by the conveying device 205, until the control unit 30 determines that the briquettes B are no longer useful. The briquettes B are thus conveyed on the reaction conveying path 212c1 several times. The control unit 30 determines that briquettes B are not useful, when the briquettes B have been conveyed on the reaction conveying path 212c1 a predetermined number of times or when a predetermined time has elapsed since the briquettes B passed through the reaction conveying path 212c1 for the first time, for example. In this case, a counter that counts the number of times that the briquettes B are conveyed on the reaction conveying path 212c1 or a timer for time measurement may be provided, for example. It should be noted that the predetermined number of times or the predetermined time described above has previously been determined on the basis of experiments or the like so that the briquettes B can maintain a suitable shape for generation of magnesium vapor with the thermal reduction reaction.

If the control unit 30 determines that the briquettes B are not useful, the conveying device 205 separates the second conveying path 212c from the second curved conveying path 212d and connects the second conveying path 212c to the briquette outlet 211. Consequently, spent briquettes B that have been used for the thermal reduction reaction are passed from the second conveying path 212c to the briquette outlet 211 and then discharged out of the retort 20. By repeating the above-described operations, a predetermined quantity of the briquettes B are conveyed on the conveying path 212.

The conveying device 205 controls a moving speed of the briquettes B in accordance with a speed indication signal from the control unit 30. The moving speed is determined so that the briquettes B are irradiated with the sunlight from the light concentrating unit 10 for a sufficient duration to generate magnesium with the thermal reduction reaction.

The temperature sensor 206 measures the temperature in the condenser shield 202 and outputs a temperature signal indicating the measured temperature to the control unit 30. The pressure sensor 207 is constituted of a first pressure sensor 207a that measures the pressure in the condenser shield 202 and a second pressure sensor 207b that measures the pressure in the retort 20 outside of the condenser shield 202. Each of the first pressure sensor 207a and the second pressure sensor 207b outputs a pressure signal indicating the measured pressure to the control unit 30. A pump 208 drives in accordance with the drive signal from the control unit 30 to regulate the pressure in the condenser shield 202 and the pressure in the retort 20 outside of the condenser shield 202 to their predetermined pressure through an intake/evacuation system (not depicted). It should be noted that the pressure in the condenser shield 202 measured by the first pressure sensor 207a represents the pressure of separated magnesium vapor during the thermal reduction reaction of the briquettes B. In absence of the magnesium vapor, the pressure in the condenser shield 202 is regulated to 1 Pa or less so that magnesium to be vaporized would not be oxidized, as described above. Additionally, the pressure in the retort 20 outside of the condenser shield 202 is regulated to 100 Pa or less in order to prevent heat transfer by convection.

The control unit 30 is an arithmetic operation unit that has CPUs, ROMs, RAMs, etc., and executes a variety of data processes. The control unit 30 inputs signals from a variety of sensors, such as the direct light sensor 104, the temperature sensor 206, and the pressure sensor 207 described above in order to monitor the light quantity of the sunlight irradiating the light concentrating unit 10, the temperature in the condenser shield 202, and the pressures in the condenser shield 202 and the retort 20. In accordance with the monitoring results, the control unit 30 performs processes, such as drive control of the light concentrating unit 10, drive control of the conveying device 205, drive control of the window member 201, etc. Details of a variety of drive control processes performed by the control unit 30 will now be described.

In order to perform the above-described variety of drive control processes, the control unit 30 includes a determination unit 301, a light-concentrating-unit drive control unit 302, a conveying device drive control unit 303, and a window member drive control unit 304. The determination unit 301 determines which one of the light concentrating unit 10, the conveying device 205, and the window member 201 should be driven, on the basis of signals input from the direct light sensor 104, the temperature sensor 206, and the pressure sensor 207. The determination unit 301 determines if the briquettes B are useful or not, as described above. In accordance with the determination result of the determination unit 301, the light-concentrating-unit drive control unit 302 calculates a drive quantity by which the light concentrating unit 10 is driven in the horizontal direction and/or in the pitch direction, and outputs it as a drive signal to the drive mechanism 105 of the light concentrating part 10.

In accordance with the determination result of the determination unit 301, the conveying device drive control unit 303 outputs a signal instructing conveying of the briquettes B into/out of the retort 20 to the conveying device 205, or calculates the conveying speed of the briquettes B and outputs a speed indication signal instructing conveying of the briquettes B at the calculated conveying speed to the conveying device 205. In accordance with the determination result of the determination unit 301, the window member drive control unit 304 outputs a drive signal instructing a drive direction and drive quantity of the window member 201 in order to two-dimensionally drive the window member 201 on a plane parallel to the x-y plane. Details of processes of the determination unit 301, the light-concentrating-unit drive control unit 302, the conveying device drive control unit 303, and the window member drive control unit 304 will be described below.

Driving of Conveying Device

If the quantity of direct solar radiation indicated by a direct solar radiation signal from the direct light sensor 104 is lower than a first threshold, the determination unit 301 determines that the intensity of the sunlight is low due to factors such as clouds or atmospheric conditions and the briquettes B are not insufficiently heated. The determination unit 301 thus determines that the duration of irradiating the briquettes B with the sunlight should be longer. In this case, the conveying device drive control unit 303 calculates a new conveying speed in accordance with the quantity of direct solar radiation so that the conveying speed of the briquettes B conveyed by the conveying device 205 is low. Then, the conveying device drive control unit 303 outputs a speed indication signal to the conveying device 205 so as to convey the briquettes B at the calculated conveying speed. Consequently, even if the intensity of the sunlight becomes low, the briquettes B can be heated to a temperature required for the thermal reduction reaction as a result of a longer duration of irradiating the briquettes B with the sunlight. When the quantity of direct solar radiation is again increased, i.e. when the quantity of direct solar radiation is not less than the first threshold, the determination unit 301 determines that the duration of irradiating the briquettes B with the sunlight should be shorter and the conveying device drive control unit 303 outputs a speed indication signal to the conveying device 205 so that the conveying speed of the briquettes B is high.

If the pressure in the condenser shield 202 indicated by the pressure signal from the first pressure sensor 207a is lower than a second threshold, the determination unit 301 determines that the amount of magnesium vapor separated with the thermal reduction reaction is low. The determination unit 301 thus determines that the thermal reduction reaction of the briquettes B should be performed over a longer duration. In other words, the determination unit 301 determines that the briquettes B should pass through the condenser shield 202 over a longer duration. Also in this case, the conveying device drive control unit 303 calculates a new conveying speed in accordance with the pressure in the condenser shield 202 so that the conveying speed of the briquettes B by the conveying device 205 is low. Then, the conveying device drive control unit 303 outputs a speed indication signal to the conveying device 205 so as to convey the briquettes B at the calculated conveying speed. As a result, the briquettes B pass through in the condenser shield 202 at a low speed and therefore the duration of irradiation by the sunlight can be longer, so that a larger amount of magnesium vapor can be separated.

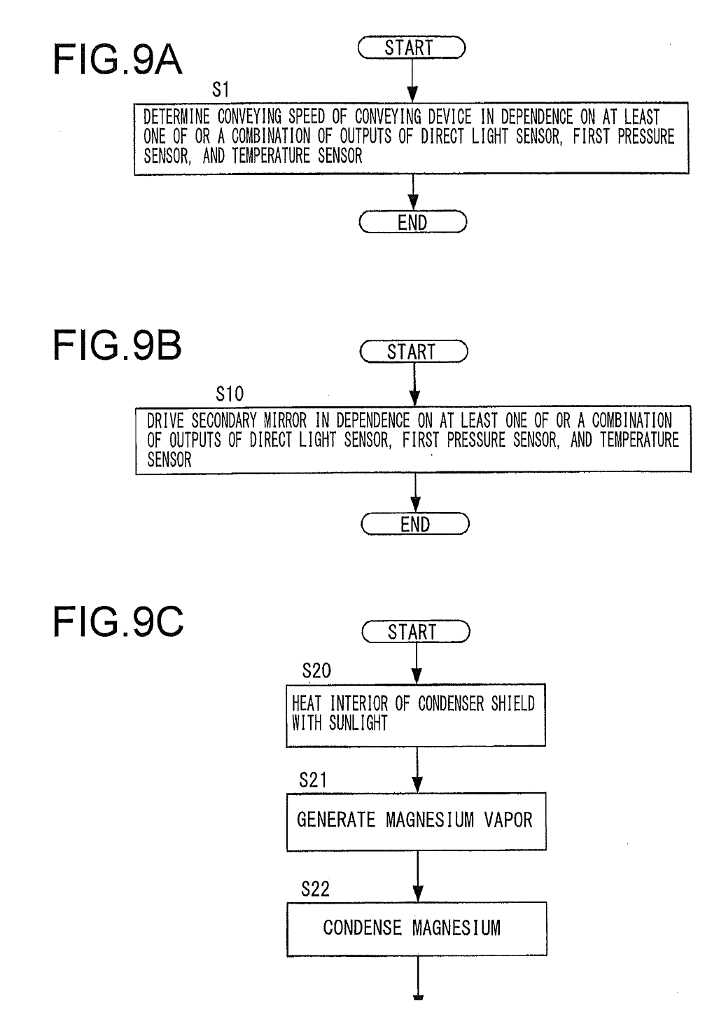

The driving process of the conveying device will be described with reference to a flowchart in FIG. 9A. In step S1, the conveying device drive unit 303 determines the conveying speed of the briquettes B carried by the conveying device 205 in dependence on at least one of or a combination of the detection results from the direct light sensor 104, the first pressure sensor 207a, and the temperature sensor 206, and the process is ended.

In order to keep the temperature in the condenser shield 202 detected by the temperature sensor 206 at 700° C. or higher, the control unit 30 outputs a drive signal to the drive mechanism 102a to slightly drive the secondary mirror 102. Accordingly, the light concentrating power of the sunlight is changed so that a reduction in the temperature in the condenser shield 202 can be suppressed. Additionally, by irradiating the condenser shield 202 with a part of the sunlight, the briquettes B can be heated while maintaining a suitable temperature. Furthermore, in order to keep the pressure in the condenser shield 202 measured by the first pressure sensor 207a at a predetermined pressure, the control unit 30 outputs a drive signal to the drive mechanism 102a to slightly drive the secondary mirror 102. Accordingly, the light concentrating power of the sunlight is changed and it is possible to prevent the quantity of magnesium vapor separated from the briquettes B from being insufficient. Thus, a reduction in productivity of a magnesium alloy can be suppressed.

The driving process of the secondary mirror 102 will be described with reference to a flowchart in FIG. 9B. In step S10, the drive mechanism 102a drives the secondary mirror 102 in dependence on at least one of or a combination of the detection results from the direct light sensor 104, the first pressure sensor 207a, and the temperature sensor 206, and the process is ended.

Driving of Window Member

The determination unit 301 outputs a drive signal to the window member drive control unit 304 to drive the window member 201 in a predetermined direction by a predetermined amount, every time when a predetermined time elapses after activation of the magnesium refining apparatus 1. The driving of the window member 201 aims to guide the sunlight to the surfaces of the briquettes B through a region of the window member 201 having a high transmittance, avoiding a region of the window member 201 where the transmittance of the sunlight is reduced due to adhesion of magnesium vapor to the window member 201. For this purpose, the above-described predetermined direction and predetermined amount by which the window member 201 is driven are predetermined so that the region of the window member 201 faces the interior of the retort 20 that is different from the region having faced the interior of the retort 20 until that point of time.

Driving of Pump

The determination unit 301 keeps the pressure in the condenser shield 202 and the pressure in the retort 20 outside of the condenser shield 202 constant, on the basis of a pressure value indicated by a pressure signal input from the pressure sensor 207. In this embodiment, a pump 208 is arranged that has an evacuating speed at which the pressure value indicated by the pressure signal input from the second pressure sensor 207b would not exceed 100 Pa.

A method of refining magnesium with the magnesium refining apparatus 1 will be described with reference to a flowchart illustrated in FIG. 9C.

In step S20, the sunlight is reflected from the main mirror 101 and advances to the secondary mirror 102. By the secondary mirror 102, the sunlight is concentrated on the briquettes B to heat the interior of the condenser shield 202 to a predetermined temperature (i.e., a temperature higher than the melting point of magnesium) and the process proceeds to step S21. Also in step S20, the drive mechanism 102a drives the secondary mirror 102 to shift the concentrating position of the sunlight at least one of on the surface of the briquette B and on the optical axis of the sunlight. In step S21, magnesium vapor is generated from briquettes B in the condenser shield 202 with the thermal reduction reaction. Then, the process proceeds to step S22. In step S22, vaporized magnesium condenses on the inner wall of the condenser shield 202. Then, the process is ended.

According to the magnesium refining apparatus according to the second embodiment described above, the following advantages can be achieved, in addition to the advantages achieved by the first embodiment.

(1) The window member 201 transmitting the sunlight concentrated by the light concentrating unit 10 is provided on the housing surface of the retort 20. The condenser shield 202 is held in the retort 20 and the briquettes B are conveyed into the condenser shield 202. As a result, it is possible to heat the briquettes B while suppressing energy loss of the sunlight. Thus, the efficiency of refining magnesium can be enhanced.

(2) The retort 20 has a second shield 203 therein that prevents attachment of magnesium vapor generated with the thermal reduction reaction to the window member 201. The range 203a is provided on a surface of the second shield 203, through which the sunlight passes after concentrated by the light concentrating unit 10 and transmitted through the window member 201. The condenser shield 202 is held in the second shield 203. Thus, by providing the second shield 203, it is possible to suppress thermal loss due to an influence of heat radiation from the condenser shield 202 that is heated to a high temperature as a result of the thermal reduction reaction, and continuously perform the thermal reduction reaction of magnesium at a high temperature. Furthermore, a deterioration speed of the retort 20 can be reduced to maintain its durability for a long time because an increase in the temperature of the retort 20 due to an influence of heat radiation can be suppressed. Moreover, it is possible to suppress a decrease in transmittance of the sunlight due to the magnesium vapor formed with the thermal reduction reaction attaching to the window member 201 provided on the retort 20. The interior of the condenser shield 202 can therefore be kept at a high temperature to maintain the efficiency of refining magnesium.

(3) The second shield 203 is configured to be coated with a reflective material on an inner or outer surface of the housing made of the transparent material, expect for the range 203a. It is therefore possible to suppress thermal loss due to an influence of heat radiation from the condenser shield 202 and continuously perform the thermal reduction reaction of magnesium at a high temperature. Thus, the efficiency of refining a magnesium alloy can be enhanced. Furthermore, a deterioration speed of the retort 20 can be reduced to maintain its durability for a long time because an increase in the temperature of the retort 20 due to an influence of heat radiation can be suppressed. Thus, the manufacturing cost of the magnesium alloy can be reduced. Additionally, heating of the housing surface of the retort 20 to a high temperature is suppressed. Thus, tasks such as maintenance, inspection, and service can be easily performed by service personnel.

(4) The range 203a of the second shield 203 is provided with the film that transmits light having a predetermined wavelength. As a result, it is possible to heat the briquettes B at a high temperature for a long time while suppressing energy loss of the sunlight. Thus, the efficiency of refining magnesium can be enhanced.

(5) One end (on the x-axis positive side) in a longitudinal direction of the retort 20 is kept lower in height than the other end (on the x-axis negative side). In the condenser shield 202, the guide members 202g (202g1 to 202g3) are provided so as to guide liquid magnesium condensed from the magnesium vapor to flow along the longitudinal direction toward the end on the x-axis positive side of the retort 20. Because the retort 20 is inclined by the angle θ with respect to the horizontal direction to utilize an effect of the gravity and the plurality of guide members 202g extend along the x-axis direction, liquid magnesium can be concentrated to a desired position, which can enhance the efficiency of recycling the condensed magnesium.

(6) The apparatus further includes the magnesium collection unit 204 that is provided under the end on the x-axis positive side of the retort 20 and collects the liquid magnesium condensed in the condenser shield 202 in a liquid state. The magnesium collection unit 204 collects the liquid magnesium dropped from the condenser shield 202 by an effect of the gravity. Liquidized magnesium can be dropped into the magnesium collection unit 204 with the aid of the effect of the gravity, which contributes to automation of the process.

(7) The apparatus further includes the briquette inlet 210 through which the briquettes B are conveyed into the retort 20, the briquette outlet 211 through which the briquettes B are conveyed out of the retort 20, and the conveying device 205 that conveys the briquettes B along the conveying path 212 that is provided in the retort 20 and connecting the briquette inlet 210 to the briquette outlet 211. At least a part of the conveying path 212 is constituted of the reaction conveying path 212c1 that extends in the condenser shield 202 in order to cause the thermal reduction reaction of the briquettes B therein. Thus, the briquettes B can be continuously conveyed into the condenser shield 202 by the conveying device 205, which contributes to automation of the process.

(8) The briquettes B are cylindrically formed and the central axes of the briquettes B aligns with the x-axis direction that is the conveying direction. The conveying device 205 conveys the briquettes B while rotating the briquettes B around the axis of the cylindrical form, at least in the condenser shield 202. This enhances the utilization efficiency of the briquettes B, because a wide range of the surfaces of the briquettes B is irradiated with the sunlight.

(9) The determination unit 301 of the control unit 30 determines if the briquettes B are useful or not and, if the determination unit 301 determines that the briquettes B are not useful, the conveying device 205 conveys the briquettes B out of the retort 20 through the briquette outlet 211. As a result, it is possible to automatically determine suitability for use of the briquettes B and convey the briquettes B that are determined to be not suitable for use out of the retort 20, which contributes to automation of the process of refining a magnesium alloy.

(10) The light concentrating unit 10 is constructed of Cassegrain optical system having the main mirror 101 constituted by the concave mirror and the secondary mirror 102 constituted by the convex mirror, which concentrates the reflected sunlight on the surface of the briquettes B in the retort 20 by guiding the sunlight reflected at the main mirror 101 to the secondary mirror 102 and then by reflecting the guided sunlight from the main mirror 101 at the secondary mirror 102. As a result, because the retort 20 can be arranged on the back side of the light concentrating unit 10, the magnesium refining apparatus 1 can have a structure in which service personnel can readily perform tasks such as replacement and service of the retort 20 without being exposed to the sunlight concentrated by the light concentrating unit 10.

(11) The drive mechanism 102a drives the secondary mirror 102 to shift the concentrating position of the sunlight at least one of on the surface of the briquette B and on the optical axis of the sunlight. Thus, the light concentrating power of the sunlight concentrating on the upper surfaces of the briquettes B can be changed to efficiently concentrate the sunlight on the briquettes B, so that the thermal reduction reaction of the briquettes B can be continuously performed at a desired temperature for a long time.

(12) The apparatus includes the direct light sensor 104 that detects direct light reaching from the sun to the light concentrating unit 10, the first pressure sensor 207a that detects the pressure in the condenser shield 202 of the retort 20, and the temperature sensor 206 that detects the temperature in the condenser shield 202. The drive mechanism 102a drives the secondary mirror 102 in dependence on at least one of or a combination of the detection results from the direct light sensor 104, the first pressure sensor 207a, and the temperature sensor 206. As a result, the light concentrating power of the sunlight can be changed when the light quantity of the sunlight is low, e.g. when the sun is hidden by clouds, or depending on conditions in the condenser shield 202. The briquettes B can thus be continuously heated at a high temperature regardless of the quantity of the sunlight to suppress a reduction in the efficiency of refining a magnesium alloy.

(13) The conveying device drive unit 303 determines the conveying speed of the briquettes B carried by the conveying device 205 in dependence on at least one of or a combination of the detection results from the direct light sensor 104, the first pressure sensor 207a, and the temperature sensor 206. As a result, the conveying device 205 can be controlled to change the conveying speed of the briquettes B to a low speed when the light quantity of the sunlight is low, e.g. when the sun is hidden by clouds, or depending on conditions in the condenser shield 202. The briquettes B can thus be heated to a desired temperature regardless of the quantity of the sunlight to maintain the productivity.

The magnesium refining apparatus according to the second embodiment can be modified as follows:

(1) Instead of flowing and dropping the liquid magnesium into the magnesium collection unit 204 through the connecting unit 202b with the effect of the gravity, the retort 20 may be vibrated to drop the liquid magnesium into the magnesium collection unit 204 owing to shock of the vibration. In this case, the apparatus further has a vibrating mechanism for vibrating the retort 20. It is here necessary to control an amplitude, a vibrating duration, a timing of vibration or the like so as to reliably achieve a desired heating temperature, avoiding that the concentrating position of the sunlight on the briquettes B varies due to vibration.

(2) The shape of the briquettes B is not limited to the cylindrical form, but may be a shape that allows the briquettes B to be conveyed on the conveying path 212. For example, the shape of the briquettes B may be formed as a prism. In this case, the conveying device 205 moves the briquettes B two-dimensionally on the x-y plane in the reaction conveying path 212c1 that is a part of the second conveying path 212c. This enhances the utilization efficiency of the briquettes B, because a wide range of the top surfaces of the briquettes B is irradiated with the sunlight.

(3) The magnesium refining apparatus 1 may be used to produce the raw material for forming the magnesium alloy, by changing the light concentrating power of the light concentrating unit 10 to change the heating temperature. In this case, the magnesium refining apparatus 1 is applicable to the process of forming MgO with calcination as represented by the above-described chemical equation (3) or the process of forming ferrosilicon with heating as represented by the chemical equation (2). As a result, it is not necessary to burn fossil fuels not only in forming the magnesium alloy, but also in calcining to form MgO or heating to form ferrosilicon, which are raw materials. Consequently, generation of carbon dioxide is suppressed and a detrimental effect on the environment is avoided for the entire system of generating the magnesium alloy. Additionally, by increasing the heating temperature to about 1200° C., instead of about 1400° C., high purity magnesium can be obtained in the magnesium refining device 1, instead of the magnesium alloy containing calcium.

Unless impairing characteristics of the present invention, the present invention is not limited to the above-described embodiments; on the contrary, other embodiments conceivable within the scope of the technical idea of the present invention are also encompassed within the scope of the present invention.

What is claimed is:

1. A magnesium refining apparatus, comprising:
a container that contains sample containing a magnesium compound; and
a light concentrating device that concentrates sunlight to irradiate the container in order to heat an interior of the container to a predetermined temperature, wherein:
the container has a reaction unit that is heated to the predetermined temperature by the light concentrating device to generate magnesium vapor from the sample with a thermal reduction reaction; and
the light concentrating device is constructed of Cassegrain optical system having a first mirror surface constituted by a concave mirror and a second mirror surface constituted by a convex mirror, and concentrates reflected light of the sunlight on a surface of the sample in the container by guiding the sunlight reflected at the first mirror surface to the second mirror surface and then by reflecting the reflected sunlight guided from the first mirror surface at the second mirror surface.

2. The magnesium refining apparatus according to claim 1, further comprising:
a drive unit that drives the second mirror surface to shift a concentrating position of the sunlight at least one of on the surface of the sample and on an optical axis of the sunlight.

3. The magnesium refining apparatus according to claim 2, further comprising:
a sun position detector that detects direct light reaching from the sun to the light concentrating device;
a pressure detector that detects a pressure in the reaction unit of the container; and
a temperature detector that detects a temperature in the reaction unit, wherein:
the drive unit drives the second mirror surface in dependence on at least one of or a combination of the detection results from the sun position detector, the pressure detector, and the temperature detector.

4. The magnesium refining apparatus according to claim 3, further comprising:
a speed determination unit that determines a conveying speed of the sample in the container in dependence on at least one of or a combination of the detection results from the sun position detector, the pressure detector, and the temperature detector.

5. A magnesium refining method, comprising:
containing sample containing a magnesium compound in a container;
heating an interior of the container to a predetermined temperature by reflecting sunlight at a first mirror surface constituted by a concave mirror and guiding to a second mirror surface constituted by a convex mirror, and then reflecting the light at the second mirror surface to concentrate the light on a surface of the sample in the container;
generating magnesium vapor from the sample with a thermal reduction reaction in a reaction unit provided in the container; and
condensing the magnesium vapor in a condenser unit provided in the container.

6. The magnesium refining method according to claim 5, further comprising:
driving the second mirror surface to shift a concentrating position of the sunlight at least one of on the surface of the sample and on an optical axis of the sunlight.

7. The magnesium refining method according to claim 6, further comprising:
detecting direct light reaching from the sun;
detecting a pressure in the reaction unit of the container;
detecting a temperature in the reaction unit; and
driving the second mirror surface in dependence on at least one of or a combination of the detected direct light, the detected pressure in the reaction unit, and the detected temperature in the reaction unit.

8. The magnesium refining method according to claim 7, further comprising:
determining a conveying speed of the sample in dependence on at least one of or a combination of the detected direct light, the detected pressure in the reaction unit, and the detected temperature in the reaction unit.
